(19) United States
(12) Patent Application Publication
(10) Pub. No.: US 2026/0250600 A1
(43) Pub. Date: Aug. 27, 2026

(54) SYSTEM AND METHOD FOR EXTRACTING VOLATILE MOLECULES FROM PLANT RAW MATERIALS

(71) Applicant: JAFER ENTERPRISES R&D, S.L.U., BARCELONE (ES)

(72) Inventors: JÉRÔME MASSON, PEYMEINADE (FR); JULIEN LE MASSON, MOUANS SARTOUX (FR); YANNICK MAESTRO, MOUANS SARTOUX (FR)

(21) Appl. No.: 18/879,283

(22) PCT Filed: Jun. 22, 2023
(86) PCT No.: PCT/EP2023/066901

§ 371 Date: Dec. 27, 2024

(30) Foreign Application Priority Data
Jun. 29, 2022 (FR) FR2206562

(51) Int. Cl. C11B 9/02; B01D 11/00; B01D 11/02

(52) U.S. Cl. CPC C11B 9/025; B01D 11/0292; B01D 2011/007

(57) ABSTRACT

The invention relates to the field of the production of natural extracts of plants and more particularly to the field of capturing volatile molecules and compounds of plant raw materials, in particular fresh flowers, including silent flowers. The invention more precisely concerns a system and a method for capturing fragrant substances of plants and making those substances available (in particular in the form of an extract on a carrier) with a view to their use, for example in the composition of a perfume. A subject of the invention is also such an extract.

### TECHNICAL FIELD

The invention relates to the field of the production of natural plant extracts and more particularly to the field of the capture of volatile molecules and compounds from plant raw materials, and in particular flowers, including silent flowers. The invention more precisely concerns a system and a method enabling capture of fragrant plant substances and making those substances available (in particular in the form of an extract on a carrier) with a view to their use, for example in the composition of a perfume. A subject of the invention is also such an extract.

### BACKGROUND OF THE INVENTION

Various extraction methods are known enabling the concentration of plant fragrances, some of which are very ancient.

The most ancient method is known as enfleurage and consists in placing freshly cut flowers on a fatty body such as animal fat and then leaving the fatty body to become impregnated with the odour of the flowers. On completion of this step the fat is used as it is or treated before use.

Also known are methods employing steam distillation or hydrodistillation techniques thanks to which the natural plant extracts are taken up by steam in order to obtain essential oils and hydrolats. Those methods are very widely used at present but have the drawback of degrading the plants used and moreover do not always enable a fragrance to be obtained that is representative of the original odour of the fresh raw material. Distillation methods also have the drawback of very low yields, that is to say that a very large quantity of raw material is necessary for a small quantity of final product. Furthermore, those methods consume particularly large amounts of energy and necessitate large quantities of water.

There are also known extraction methods using a solvent. Those methods consist in leaving the plant in a tank filled with a solvent, generally a solvent of petrochemical origin, until the solvent is impregnated with the odours of the plant.

The solvent is then eliminated by evaporation. Those methods have the drawback of being time-consuming and also of necessitating large quantities of petrochemical solvent, often a pollutant and a hazardous material, the presence of which in the finished products is regulated.

Also known are methods using CO₂ in the supercritical state. In the supercritical state CO₂ acts as a solvent enabling extraction of the fragrant molecules. Methods using supercritical CO₂ generally enable extracts to be obtained the odour of which is more faithful to that of the raw material than the methods mentioned hereinabove. These are still methods that are costly to use. Furthermore, these methods are generally somewhat incompatible with the use of fresh raw materials.

Finally, the document EP 2 644 039 describes a device for extracting fragrancing ingredients of a plant constituting an alternative to the enfleurage technique. That device comprises an extraction enclosure that contains a receptacle for the plants such as flowers (Jasmin, rose, tuberose, etc.) and has a flow of gas passed through it. The gas is then guided via a compressor into a collecting enclosure where the fragrant substances that it contains are trapped by a solvent which may be a vegetable oil.

The invention stems from the observation that there is not known at present any method for capturing volatile molecules that enables a product to be obtained the odour of which is exactly representative of the odour of the plant, in particular its head notes. Furthermore, the existing methods do not capture the odours of some plants, in particular so-called “silent” plants such as lily of the valley, hyacinth, lilac, freesia, etc. A flower is generally considered silent if it satisfies one or both of the following conditions:
a very low yield from extraction of its compounds of interest by the known methods, and
a final extract of poor olfactory quality obtained by the known methods.

### SUMMARY OF THE INVENTION

The present invention has for objective remedying the drawbacks of the prior art and in particular those described hereinabove by proposing a system and a method for extraction of plant natural extracts that enable an extract to be obtained that is representative of the odour of the raw material. The invention also has for objective proposing an extraction method and system that do not employ polluting or hazardous materials and have an energy efficiency that may be higher than known extraction methods.

To this end the invention concerns a system for extraction of volatile molecules from a plant raw material, including:
at least one enclosure including a plurality of receptacles configured to receive a plant raw material, the enclosure being hermetically sealed against entry of gases and including an inlet and an outlet disposed at two ends of the enclosure, the enclosure being configured to generate a circulation of gas in the enclosure by each receptacle, with a closely similar or equal gas flow by each receptacle,
a compression device configured to adjust the pressure of the air or of a gas circulating from the enclosure to a capture system at a relative pressure greater than or equal to 2 bar,
   the capture system including:
a first capture device at least partly filled with a first solvent so as to enable an exchange between the first solvent and the compressed gas entrained by the compression device, and
a second capture device comprising an inlet connected to a pipe enabling air evacuated from the first capture device to be drawn into the second capture device, the second capture device being at least partially filled with a second solvent so as to enable an exchange between the second solvent and the compressed gas that has passed through the first capture device.

The invention also concerns a method of extracting volatile molecules from a plant raw material such as flowers, the extraction method comprising the following steps:
distributing a plurality of portions of a plant material in an enclosure fed with a gas such as air and configured to generate a circulation of said gas through each portion of plant material with a close or equal gas flowrate by each portion,
extracting the gas having circulated over all the plant material portions and compressing it to a relative pressure greater than or equal to 2 bar,
capturing the compressed gas in a first organic solvent having a solubility in water less than or equal to 20 wt % and separating by condensation the steam contained in the gas to obtain an depleted gas, a first organic phase and a first aqueous phase,
capturing the depleted gas in a second organic solvent having a solubility in water less than or equal to 20 wt %, preferably identical to the first organic solvent, and separating by condensation the steam contained in the gas to obtain a second organic phase, a second aqueous phase and a gas that is further depleted that is optionally recycled in step (a),
combining the two organic phases and optionally the organic compounds present in the two aqueous phases to obtain a plant extract.

It also concerns a plant extract obtained by the above method, in particular an extract obtained from plant material consisting of silent flowers.

### DETAILED DESCRIPTION

The invention concerns a method and device for extracting aromatic compounds from a plant material, and the extract obtained in this way.

By plant material is meant a fresh plant material, possibly washed, or a plant material that has undergone at least one mechanical treatment (for example blowing), chemical treatment (for example oxidation) and/or heat treatment (in particular drying, grilling or freeze drying) after harvesting and from which fragrant molecules can be extracted. This is preferably a fresh plant material, that is to say any type of plant freshly picked or cut and not dried. The plant material may be any part of any plant and in particular consist of leaves, flowers, fruits, stems, heads, needles, roots or mixtures thereof. There are more particularly used flowers, in particular flowers of Jasmin, rose, tuberose, or perfume flowers and flowers described as silent in the field of perfumery, in particular lily of the valley, hyacinth, lily, honeysuckle, lilac, gardenia, violet, carnation, sweet pea, buddleia or peony.

The extraction system conforming to the invention utilises a circulation of gas, in particular of air, at a temperature advantageously close to or equal to the ambient temperature to entrain toward a solvent the volatile molecules emitted by the raw material placed in the enclosure. By avoiding heating of the enclosure (or heating it to an excessive temperature) and avoiding premature contact between the raw material and a substance (such as steam, a solvent or other chemical product) liable to degrade some of the volatile molecules responsible for the original odour of the raw material, it is certain that all of the volatile molecules emitted can be captured without deterioration (or with negligible deterioration) by the extraction system. By using circulation of gas under pressure the system conforming to the invention makes it possible to increase the exchanges between the compressed gas and the solvents contained in the capture devices, thereby increasing the efficacy of the capture of the volatile molecules by the solvent or solvents. Thus the efficacy and the extraction yield of the extraction system are increased, in particular making them compatible with use on an industrial scale. The system constituting the object of the invention further enables treatment of a plurality of successive quantities of raw material using the same quantity of solvent and thus obtaining a higher concentration of volatile molecules in the solvent. The system conforming to the invention is particularly suited to solvents of non-petrochemical origin. The extraction system conforming to the invention is therefore more ecological than known systems and methods and facilitates compliance of the finished products with legislation, in particular where the presence of residual solvents is concerned. Finally, the system conforming to the invention is compatible with so-called silent flowers.

The above objectives are achieved in particular by virtue of the fact that the enclosure is configured to generate circulation of gas within the enclosure by each receptacle with a gas flowrate that is equal or nearly equal by each receptacle. To this end a number of types of configuration can be envisaged.

In a first embodiment the enclosure includes an inlet and an outlet disposed at respective opposite ends of the enclosure and the inlet of the enclosure is connected to a gas or air distribution column passing through the enclosure, the distribution column including a tubular body, the tubular body including a plurality of perforated longitudinal sections including distribution orifices by each receptacle, each perforated section being disposed between two adjacent receptacles, the cumulative area of the orifices of each successive perforated section decreasing from the inlet to the outlet of the enclosure.

In one embodiment the orifices are of identical size and shape, the number of orifices in each successive perforated section decreasing from the inlet to the outlet of the enclosure.

In another embodiment the enclosure includes an exterior envelope and an interior envelope, the interior envelope including a plurality of perforated longitudinal sections including distribution orifices by each receptacle, each perforated section being disposed between two adjacent receptacles, the cumulative area of the orifices of each successive perforated section decreasing from the inlet to the outlet of the enclosure.

In a first variant of this embodiment the enclosure comprises a gas or air distribution column including perforated longitudinal sections by each receptacle and the distribution column is connected to the outlet of the enclosure.

In a second variant of this embodiment the receptacles comprise perforated lower and upper walls.

In another embodiment the enclosure includes a plurality of receptacles disposed side-by-side and the inlet of the enclosure is connected to a gas or air distribution column including a tubular body, the tubular body including a plurality of perforated longitudinal sections including distribution orifices by each receptacle, the cumulative area of the orifices of each successive perforated section decreasing along the distribution column, from the inlet of the enclosure. In a further embodiment the enclosure includes a plurality of removable receptacles around a horizontal axis, the inlet of each receptacle including gas or air distribution orifices.

The supplementary embodiments described hereinafter are compatible with each of the embodiments of the enclosure described above.

In one embodiment the compression device includes an inlet connected to the outlet of the enclosure so as to aspirate the gas contained in the enclosure and includes an outlet connected to an inlet of the first capture device.

In one embodiment the compression device is configured to produce a pressure above 2 bar, for example above 4 bar.

In one embodiment the compression device is configured to produce a pressure between 4 and 6 bar inclusive.

In one embodiment the compression device is configured so that the flowrate of circulating gas at the outlet of the enclosure when the volume of the enclosure is between 100 and 200 litres inclusive is greater than 20 litres per minute, preferably less than 100 litres per minute, and for example between 30 and 80 litres per minute inclusive.

In one embodiment the compression device is an oil-free type compressor.

In one embodiment the extraction system includes two enclosures, the outlet of each enclosure being connected to the inlet of the compression device.

In one embodiment the extraction system includes a selection device enabling activation or deactivation of the circulation of gas in each enclosure, the selection device enabling activation of the circulation of gas either selectively in one or the other of the two enclosures or in both enclosures simultaneously, the selection device including for example one or more valves.

In one embodiment the selection device is controlled automatically, for example by means of a timer device.

In another embodiment the extraction system includes two or more enclosures disposed inside a container, each of the enclosures including one or more gas inlets and one or more gas outlets connected to a single gas outlet of the container.

In one embodiment the receptacles are stacked, each receptacle including a bottom wall and preferably a peripheral side wall.

In one embodiment the bottom wall and/or the side wall of each receptacle includes a plurality of gas circulation orifices.

In one embodiment the first solvent has a solubility in water less than or equal to 20% and preferably less than or equal to 10%.

In one embodiment the second solvent is identical to the first solvent or different from the first solvent, the second solvent being then miscible with the first solvent. In one embodiment the second solvent has a solubility in water less than or equal to 20% and preferably less than or equal to 10%.

In one embodiment the first capture device and/or the second capture device include(s) a means for generating bubbles in the first and/or the second solvent, respectively, such as a turbine, a sintered filter, a nebulisation system or an ultrasound probe. It is preferably a porous metal filter, for example a filter of sintered metal type, so that the gas entering the first capture device is made to pass through the filter before coming into contact with the first solvent and/or the gas entering the second capture device is made to pass through the filter before coming into contact with the second solvent.

In one embodiment the first capture device and/or the second capture device include(s) a part forming a container for the condensed water resulting from the condensation occurring during the circulation of gas in the extraction system.

In one embodiment the first capture device and/or the second capture device include(s) a device for draining the condensed water, the draining device optionally being controlled automatically.

As indicated hereinabove the invention also concerns an extraction method employing the extraction system defined hereinabove.

The invention precisely concerns a method of extracting volatile molecules from a plant raw material such as flowers, the method comprising the following steps: distributing a plurality of portions of a plant material in an enclosure fed with a gas such as air and configured to generate a circulation of said gas through each portion of plant material with a close or equal gas flowrate by each portion,
extracting the gas having circulated over all the plant material portions and compressing it to a relative pressure greater than or equal to 2 bar,
capturing the compressed gas in a first organic solvent having a solubility in water less than or equal to 20 wt % and separating by condensation the steam contained in the gas to obtain an depleted gas, a first organic phase and a first aqueous phase,
capturing the depleted gas in a second organic solvent having a solubility in water less than or equal to 20 wt %, preferably identical to the first organic solvent, and separating by condensation the steam contained in the gas to obtain a second organic phase, a second aqueous phase and a gas that is further depleted that is optionally recycled in step (a),
combining the two organic phases and optionally the organic compounds present in the two aqueous phases to obtain a plant extract.

By “depleted gas” is meant that the gas no longer contains some of the volatile components that it contained before entering the first capture device. By “further depleted gas” is meant that the gas no longer contains some of the volatile components that it contained before entering the second capture device.

In a preferred embodiment the method according to the invention is executed by an extraction system as described above and in the remainder of the present description. The method then comprises the following steps:
disposing a plant raw material in the enclosure,
extracting the gas contained in the enclosure, for example by aspiration via the outlet of the enclosure,
compressing the extracted gas to a relative pressure greater than or equal to 2 bar,
causing the compressed gas to circulate in the first capture device,
causing the gas exiting the first capture device to circulate in the second capture device.

In one embodiment the extraction, compression and circulation of gas steps are executed in successive cycles, the extraction system being stopped between two successive operating cycles.

In one embodiment the duration of each cycle corresponds to a first predetermined duration, in particular a duration greater than 15 minutes and for example equal to 30 minutes.

In one embodiment the time for which the system is stopped corresponds to a second predetermined duration, the second predetermined duration being for example equal to the first predetermined duration.

In one embodiment the duration of each cycle corresponds to the time necessary for the compressed gas to reach a predetermined relative pressure, for example a relative pressure between 2 and 10 bar inclusive or between 4 and 6 bar inclusive.

In one embodiment the time for which the extraction system is stopped corresponds to the time necessary for the relative pressure of the compressed gas to reach zero.

In one embodiment the method employs an extraction system including at least two enclosures and the extraction step is executed alternately in each enclosure.

The present invention will be better understood on reading the following detailed description with reference to the appended drawings in which:

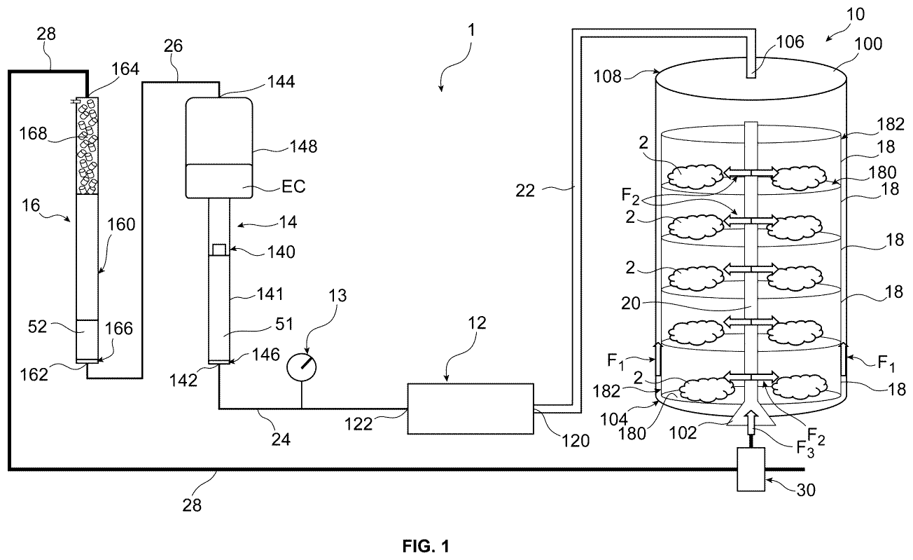

FIG. 1 is a diagrammatic view of an extraction system conforming to the invention.

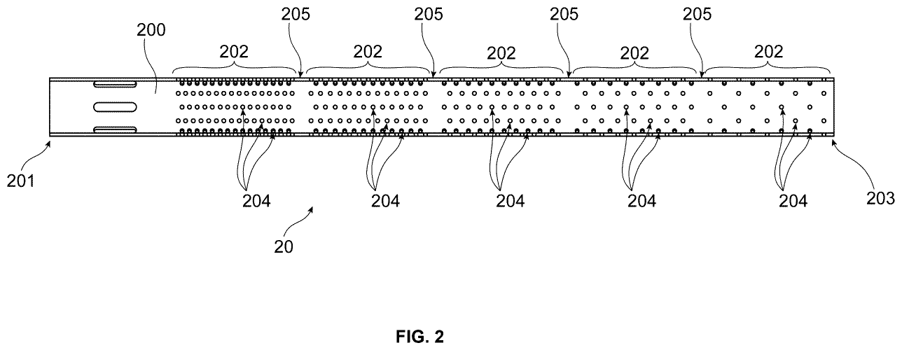

FIG. 2 is a view of a gas distribution column.

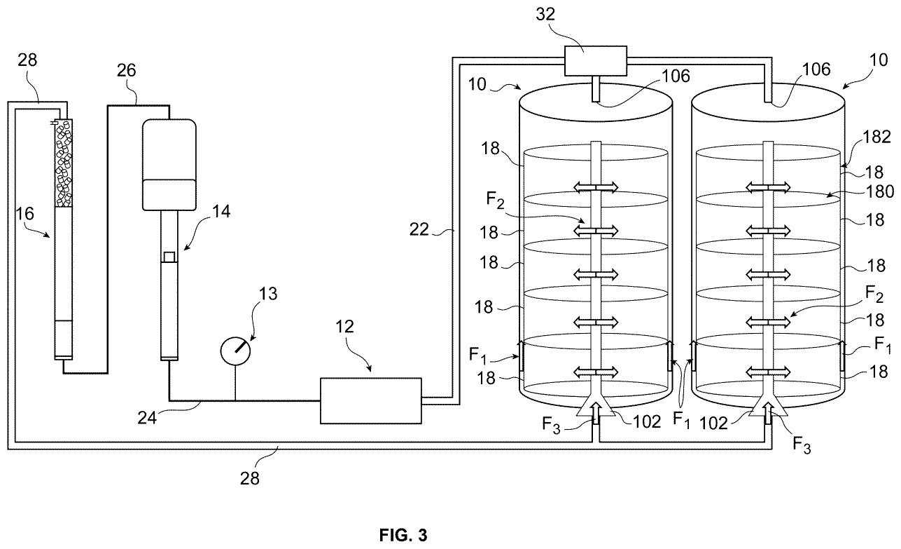

FIG. 3 is a diagrammatic view of an extraction system conforming to the invention including two enclosures.

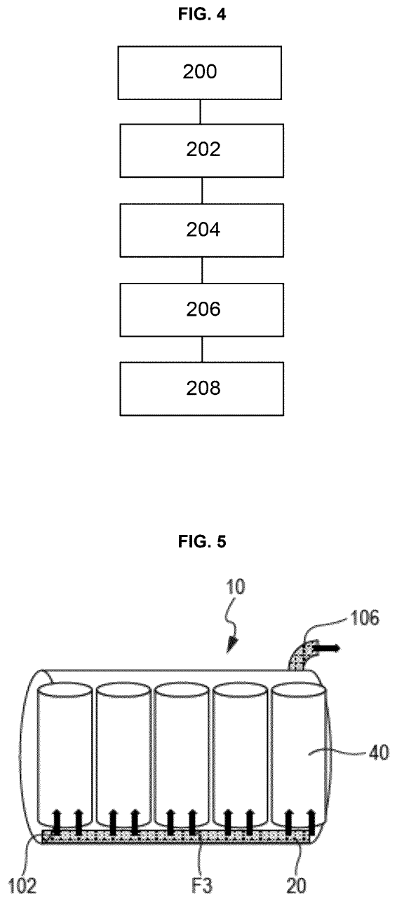

FIG. 4 represents the steps of an extraction method conforming to the invention.

FIG. 5 depicts a variant of the extraction system according to the invention.

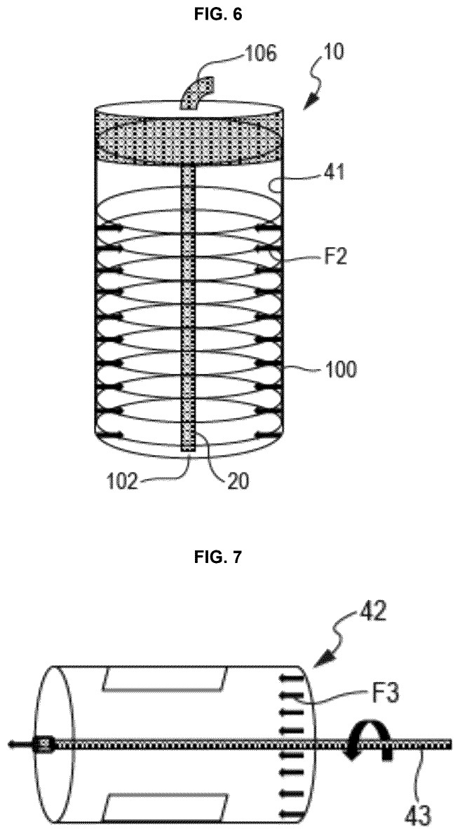

FIG. 6 depicts a second variant of the extraction system according to the invention.

FIG. 7 depicts a third variant of the extraction system according to the invention.

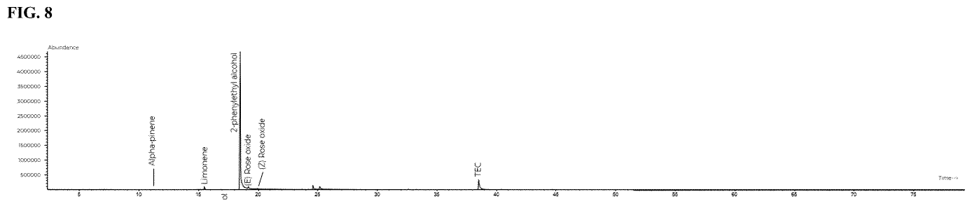

FIG. 8 is a chromatogram depicting the composition of a rose absolute.

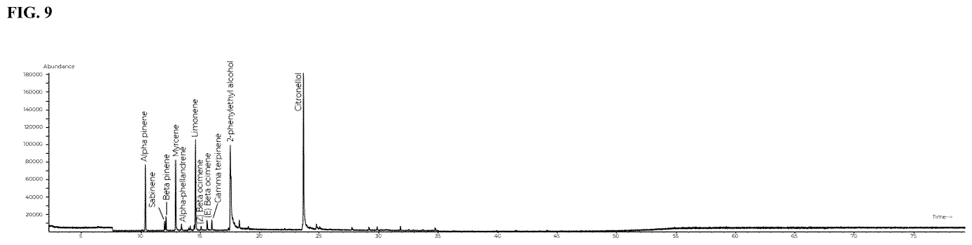

FIG. 9 is a chromatogram depicting the composition of rose flowers.

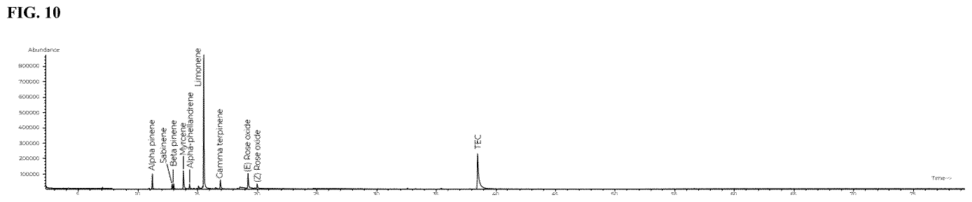

FIG. 10 is a chromatogram depicting the composition of a rose extract obtained according to the invention.

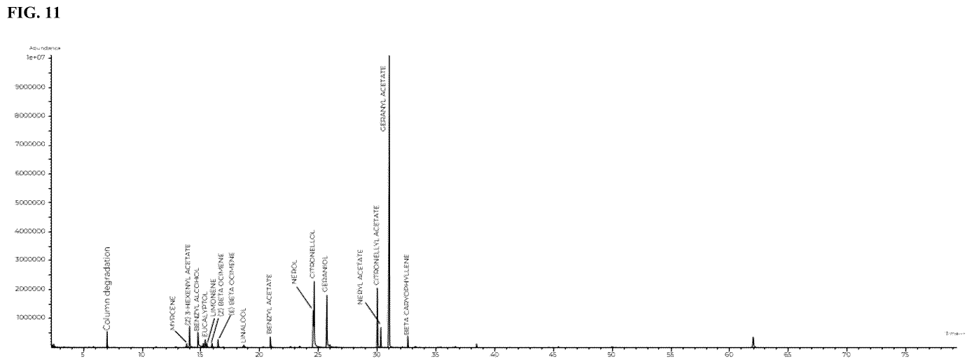

FIG. 11 is a chromatogram depicting the composition of lily of the valley flowers.

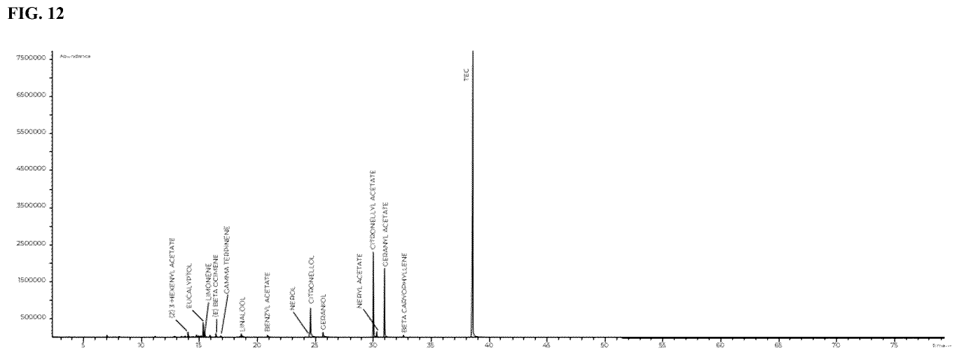

FIG. 12 is a chromatogram depicting the composition of an extract of lily of the valley obtained according to the invention.

FIG. 1 is a diagrammatic view of one example of an extraction system 1 conforming to the invention. The extraction system 1 includes a depositing enclosure 10 enabling depositing of a fragrant raw material 2, in particular a fresh plant raw material, such as flowers 2. The extraction system 1 further includes a compression device 12 and a capture system 14, 16. In this example the capture system includes a first capture device 14 and a second capture device 16. The extraction system 1 is configured to cause a gas that may in particular be air to circulate through the enclosure 10 so as to entrain a mixture of gas (or air) and volatile molecules emitted by the raw material 2 deposited in the enclosure 10 into the capture system 14, 16. In this example the compression device 12 is disposed between the enclosure 10 and the capture system 14, 16 so as to aspirate the gas contained in the enclosure 10, that gas being air in this example.

The aspirated air is compressed by the compression device 12 and drawn toward the first capture device 14. The passage of the air into the first capture device 14 enables capture of some of the volatile molecules mixed with air. The air is then drawn into the second capture device 16. The second capture device 16 enables the capture of volatile molecules not captured by the first capture device 14.

The enclosure 10 includes a gastight body 100, in this example a body 100 of elongate straight cylindrical general shape extending along a vertical axis of symmetry. By “gastight” is meant that the enclosure 10 is in particular sealed against entry of the surrounding air except for air entering the enclosure 10 via an inlet 102 in the body 100, in this example by a lower end 104 of the body 100, and an outlet 106 in the body 100, in this example by an upper end 108. The internal volume of the enclosure in this example is between 150 and 160 litres inclusive. The enclosure 10 includes a plurality of receptacles 18 configured for depositing the raw material, such as the fresh flowers 2. The enclosure 10 further includes a gas distribution column 20 disposed in the body 100. The distribution column 20, which is described in more detail hereinafter, includes a hollow body 200 connected to the air inlet 102 and including one or more perforated sections 202. The perforated sections 202 enable circulation of gas/air between the interior and the exterior of the body 200 and therefore between the inlet 102 and the interior space of the enclosure 10 situated around the distribution column. Thus when the compression device 12 aspirates air contained in the enclosure 10 a circulation of air is generated from the inlet 102 to the outlet 106 of the enclosure and the incoming air (arrow F₃) is constrained to pass through the interior of the body 200 of the distribution column 20 and thereafter through the perforated sections 202 of the body 200, thereafter to exit the enclosure 10 via the outlet 106. In this example the distribution column 20 is disposed in the central part of the body 100 along the axis of symmetry of the body 100. The inlet 102 of the enclosure 10 is advantageously equipped with a filter, such as a carbon filter, enabling filtering of the air entering the enclosure 10 in order for that air to be free of any olfactory pollution.

The compression device 12 includes an inlet 120 that is connected to the outlet 106 of the enclosure 10 by means of a first pipe 22 and an outlet 122 that is connected to the first capture device 14 by means of a second pipe 24. The compression device 12 is configured to aspirate air contained in the enclosure 10 and to compress that air, which is charged with volatile molecules from the raw material 2 deposited in the enclosure 10. The compression device 12 is in this example a dry compressor (that is to say one of the oil-free type), which avoids polluting the air circulating in the extraction system 1. In fact a lubricated compression device 12 would be liable to generate pollution in the extraction system, in particular by releasing lubricant particles into the gas/air circuit, which would compromise the quality of the final product, which could contain particles of lubricant (and what is more the lubricant could be contaminated by volatile molecules from preceding extractions). The compression device 12 is configured to generate at the outlet a relative pressure greater than or equal to 2 bar or 3 bar. The compression device 12 is advantageously capable of generating a relative pressure between 4 and 5 bar inclusive or between 4 and 6 bar inclusive. Providing a compression device disposed downstream of the enclosure 10 enables generation of a circulation of air in the enclosure 10 by aspiration, which is better for the entrainment of the volatile molecules from the flowers 2 disposed in the enclosure 10 compared to a circulation of air generated by reducing the pressure in the enclosure 10, which would moreover be more liable to generate turbulence damaging to the operation of the system and for the raw material contained in the enclosure 10. The compression device 12 is configured to generate a flow of air (or of gas) that is sufficient to entrain air contained in the enclosure and remains sufficiently low not to generate too much turbulence in the enclosure 10 and in particular not to generate turbulence liable to move the raw material. By way of example, for an enclosure 10 having a volume of approximately 100 to 200 litres a compression device 12 could be provided generating a flow of air at the inlet of the device between 30 and 100 litres per minute inclusive and a flow of air at the outlet of the device between 10 and 50 litres per minute inclusive. Also by way of example, for an enclosure 10 having a volume of approximately 160 litres the compression device 12 will be designed to generate a flow of air at the inlet of 50 litres per minute and a flow at the outlet of 20 litres per minute. Of course, the flow of air that the compression device is able to generate at the inlet (and therefore at the outlet of the enclosure 10) will depend in particular on the internal volume of the enclosure 10.

The first capture device 14 includes a body 140 forming a column type container and has an inlet 142 connected to the second pipe 24 and an outlet 144 connected to a third pipe 26 connecting the first and second capture devices 14, 16. The inlet 142 is disposed at the lower end of the body 140 and enables the admission of compressed air coming from the compression device 12 whereas the outlet 144 is disposed at the higher end of the body 140 and enables evacuation of air to the third pipe 26 and therefore to the second capture device 16. The body 140 is partly filled with a first solvent S1 and to this end includes a first part 141 forming a container for the first solvent S1. The first solvent is chosen from solvents suitable for the formulation of perfumes and is preferably a natural and non-polluting solvent. A porous metal filter 146, for example of sintered metal type, is disposed by the inlet 142 so that air entering the body 140 is constrained to pass through the filter 146 before coming into contact with the first solvent. When the air coming from the compression device 12 is admitted into the first capture device 14 a bubbling phenomenon is generated thanks to the filter 146, enabling exchange between the compressed air and the first solvent. This exchange leads to the capture of at least a first portion of the volatile molecules contained in the air by the first solvent. It is clearly understood that another bubble generation system may be used instead and in place of the filter 146. The efficacy of the capture effected thanks to the passage of air into the solvent is improved thanks to the compression of the air, the exchanges between the air and the solvent being increased by the pressure of the air. In order to optimise the exchanges between the compressed air and the first solvent the filter 146 preferably has a porosity between 10 and 100 microns inclusive, preferably between 20 and 60 microns inclusive, and for example equal to 20 microns. A fine porosity favours the generation of small bubbles of air (or of gas) and enables a greater area of exchange to be provided between the first solvent and the air. In this example the filter 146 is a sintered stainless steel filter. The volume of first solvent is advantageously greater than or equal to 400 ml, and in particular between 500 ml and 2000 ml inclusive or between 500 ml and 1200 ml inclusive or between 600 ml and 1100 ml inclusive and for example equal to 900 ml. Of course, the volume of solvent will be determined as a function of the quantity of raw material that can be deposited in the enclosure 10 and therefore as a function of the volume of the enclosure 10. In this regard a volume of solvent greater than 2000 ml could of course be envisaged.

The body 140 of the first capture device 14 advantageously includes a second part 148 situated between the first part 141 and the outlet 144 forming a container for storage of the condensed water EC, that is to say the water resulting from the condensation of the water contained in the air entering the first capture device (water coming from the air entering the enclosure 10 and from the raw material 2). The second part 148 is of course in fluid communication with the first part 141. The respective volumes of these two parts are determined so that the first part 141 is able to contain all of the quantity of first solvent required and so that the second part preferably has a volume sufficient to receive all of the condensed water, for example a volume between 4 and 10 litres.

The air admitted into the first capture device 14 is evacuated via the outlet 144 and entrained in the third pipe 26 to the second capture device 16. The second capture device 16 includes a body 160 forming a column type container and includes an inlet 162 connected to the third pipe 26 and an outlet 164 that may be either a free outlet or connected to a fourth pipe 28 connecting the second capture device to the inlet 102 of the enclosure 10. The inlet 162 is disposed at a lower end of the body 160 and enables admission of compressed air that has passed through the first capture device (14) whereas the outlet 164 is disposed at the higher end of the body 160 and enables evacuation of air from the second capture device 16. The body 160 is partly filled with a second solvent S2 chosen among the solvents suitable for the formulation of perfumes and is preferably a non-polluting natural solvent. Furthermore, the second solvent is chosen to be miscible in the first solvent. A porous metal filter 166, for example of sintered metal type, is disposed by the inlet 162 so that air entering the body 160 is constrained to pass through the filter 166 before reaching the second solvent. When the air coming from the first capture device 14 is admitted into the second capture device 16 a phenomenon of bubbling is generated thanks to the filter 166. As for the first capture device, the passage of air into the second solvent leads to the capture of volatile molecules contained in the air by the second solvent and the bubbling system is not limited to a sintered filter. The passage of compressed air into the second solvent therefore enables capture of a second part of the volatile molecules from the air and recovery of those molecules in the second solvent. As for the first solvent, the efficacy of the capture effected thanks to the passage of air into the second solvent is improved thanks to the compression of the air, the exchanges between the air and the solvent being increased by the pressure of the air. In order to optimise the exchanges between the compressed air and the second solvent the filter 166 preferably has a porosity between 10 and 100 microns inclusive, preferably between 20 and 60 microns inclusive, and for example equal to 20 microns. In this example the filter 166 is a sintered stainless steel filter. The volume of the second solvent is advantageously greater than or equal to 50 ml and in particular between 50 ml and 300 ml inclusive or between 50 ml and 200 ml inclusive and for example equal to 100 ml. The body 160 of the second capture device 16 advantageously includes a compartment in the upper part in which is disposed a condensation device 168 which in this example includes Raschig rings. The condensation device 168 enables optimisation of the condensation of volatile molecules that have remained mixed with the air and have not been captured by the solvents. Alternatively the condensation device 168 may include a nebulisation device.

The first solvent is advantageously hydrophobic in order to prevent it from dissolving (or so that it dissolves only in very limited quantities) in the water contained in the air circulating in the extraction system 1 or in the water condensed in the first capture device 14. The first solvent preferably has a solubility in water less than or equal to 20 wt %, preferably less than or equal to 10 wt %, or again less than or equal to 5 wt %. The first solvent is an organic solvent that the person skilled in the art will be able to choose as a function of the extracted plant material and that advantageously comprises: at least one alkyl ester, at least one triglyceride (in particular C8/C10 acid triglyceride); at least one fatty acid, for example a C12-C22 carboxylic acid; at least one fatty alcohol, for example of C6-C20 type, and mixtures thereof. An alkyl ester is preferably used, in particular triethyl citrate (TEC). If a quantity of solvent is found to be dissolved in the condensed water EC in the reservoir 148 of the first capture device 14 the solvent dissolved in water could be recovered after use of the extraction system 1, also including as it does some of the captured volatile molecules.

The second solvent is advantageously also hydrophobic and preferably has a solubility in water less than or equal to 20%, or less or equal to 10% or again less than or equal to 5%. The second solvent is an organic solvent that the person skilled in the art will be able to choose as a function of the extracted plant material and that advantageously comprises: at least one alkyl ester, at least one triglyceride (in particular C8/C10 acid triglyceride); at least one fatty acid, for example a C12-C22 carboxylic acid; at least one fatty alcohol, for example of the C6-C20 type, and mixtures thereof. An alkyl ester is preferably used, in particular triethyl citrate (TEC). The second solvent may be identical to or different from the first solvent. The first and second solvents are preferably identical. When the second solvent is different from the first solvent it is as mentioned above chosen so as to be miscible with the first solvent so that following the capture of the molecules contained in the air circulating in the extraction system 1 the two solvents can be mixed and thus provide a product directly usable by the perfume manufacturing industries.

The extraction system 1 preferably includes a device 13 for measuring relative pressure disposed in this example at the outlet of the compression device 12. The extraction system 1 advantageously includes a device for adjusting the maximum pressure at the outlet of the compression device 12, such as a needle valve. Additionally or alternatively the extraction system 1 may include a pressure regulation device.

When the extraction system 1 includes a fourth pipe 28 at the outlet of the second capture device 16 the fourth pipe 28 is connected to the inlet 102 of the enclosure 10 via an admission device 30. The admission device 30 is configured to produce a mixture including one part of air coming from the second capture device 16 and one part of air coming from outside the extraction system 1. The proportion of air coming from the second capture device 16 may advantageously be adjusted, preferably in a range varying between 0% and 100%. Thus the admission device 30 enables air entering the enclosure 10 to be exclusively air coming from outside the extraction system 1 or the incoming air includes some air having already circulated through the extraction system 1.

An embodiment of the enclosure 10 and of the aspiration column 20 is described hereinafter with reference to FIGS. 1 and 2. As described above, the enclosure 10 includes a plurality of receptacles 18 in which flowers 2 can be deposited. In this example the receptacles 18 are stacked and each has a general shape adapted to suit the shape of the body 100 of the enclosure 10. In this example the receptacles 18 therefore have a general shape exhibiting symmetry of revolution about the axis of symmetry of the body 100. As can be seen in FIG. 1 the dimensions of the receptacles 18 are advantageously chosen so that a space is defined between the periphery of each receptacle 18 and the internal side wall of the body 100 of the enclosure 10. A vertical circulation of air (or of gas) can therefore be generated along the internal wall of the body 100 when the extraction system 1 is functioning (arrows F₁).

Each receptacle 18 includes a bottom wall 180 forming a surface on which to deposit the flowers. The bottom wall 180 may be a solid wall or a perforated wall so as to allow a flow of air through the bottom wall. The two end receptacles, that is to say the receptacles situated in the immediate vicinity of the inlet 102 and the outlet 106, respectively, have a solid bottom wall 180 whereas all the receptacles situated between the two end receptacles have a perforated bottom wall 180. Such a configuration makes it possible to favour the vertical circulation of air mentioned hereinabove.

The receptacles 18 may include a peripheral side wall 182 so that each receptacle forms a container. When the receptacles 18 include a side wall 182 the latter is preferably perforated so as to include a plurality of orifices distributed over all or part of the periphery of the corresponding receptacle 18. Whether the receptacles 18 include a side wall 182 or not, they are therefore configured to allow circulation of air by each receptacle oriented in a direction perpendicular to the axis of symmetry of the body 100 and therefore in a direction parallel to the corresponding bottom wall 180 (arrows F₂).

As mentioned above the distribution column 20 is disposed in the central part of the body 100. The distribution column 20 includes a hollow body 200 of tubular shape in this example. The body 200 has a general shape exhibiting symmetry of revolution about the axis of symmetry of the body 100. The body 200 is open at a first or lower end 201 in order to be connected to the inlet 102 of the enclosure 10. The opposite or upper end 203 of the body 200 is closed. The body 200 includes a plurality of perforated longitudinal sections 202, adjacent perforated sections 202 being separated by a non-perforated section 205. Each perforated section 202 includes a plurality of distribution orifices 204, each orifice 204 providing fluid communication between the interior and the exterior of the body 200. The distribution column 20 includes as many perforated sections 202 as the enclosure 10 includes receptacles 18. The distribution column 20 is configured so that each perforated section 202 is located above the level of the bottom wall 180 of the corresponding receptacle 18 (each bottom wall being located by a non-perforated section 203). The orifices 204 of a perforated section 202 are therefore disposed between the bottom walls 180 of two adjacent receptacles 18. The cumulative area of the orifices 204 of each consecutive perforated section 202 decreases from the lower end 201 to the upper end 203 and therefore from the inlet to the outlet of the enclosure 10. Thus the farther the perforated section 202 is from the outlet 106 of the enclosure 10 (and therefore from the source of negative pressure) the easier is the passage of air through the body 200. This configuration enables a flow of air through the distribution column 20 to be obtained that is relatively homogeneous along the latter. In other words, an equivalent flow of air is provided by each receptacle 18. The distribution orifices 204 are preferably of identical size and shape, the orifices 204 in this example having a circular cross section. The number of distribution orifices in each successive perforated section 202 decreases from the inlet to the outlet of the enclosure 10, i.e. from the lower end 201 to the upper end 203 of the distribution column 20.

In order to facilitate loading the enclosure with the raw material 2 the receptacles 18 are advantageously removable. Each receptacle is preferably engaged around the body 200 of the distribution column 20 and to this end includes an opening in the bottom wall 180, the opening having a shape complementary to the shape of the cross section of the body 200, in this example a circular opening. FIG. 3 represents a variant of the extraction system 1 from FIG. 1 in which the system includes two analogous enclosures 10. Providing two enclosures 10 enables twice the quantity of flowers to be deposited. The air contained in the enclosures 10 may be extracted simultaneously or advantageously alternately.

When the extraction system 1 includes two enclosures 10 a selection device 32 including for example at least one valve preferably enables selection of from which enclosure 10 air will be extracted when the extraction system 1 is functioning. The selection device 32 preferably enables extraction of air in one or the other of the enclosures 10 or in both enclosures 10 simultaneously. The selection device 32 can be controlled automatically, for example by means of a timer device. When the extraction system includes two enclosures the extraction of air may advantageously be effected alternately in each enclosure, for example for identical predetermined times for each enclosure.

FIGS. 5 to 7 depict other embodiments of the extraction system according to the invention.

The system represented in FIG. 5 includes an enclosure (10) provided with an air inlet (102) and an air outlet (106) that encloses a series of (here five) receptacles (40) disposed side-by-side. The entry of the enclosure (10) is connected to a gas or air distribution column (20) including a tubular body, the tubular body including a plurality of perforated longitudinal sections including distribution orifices (not represented) by a bottom wall of each receptacle (40) so that a flow of air (F3) circulates at the same flowrate in each receptacle. To this end the cumulative area of the orifices of each successive perforated section decreases along the distribution column from the inlet (102) of the enclosure (10). In the variant represented in FIG. 6 the enclosure (10) includes an exterior envelope corresponding to the body (100) and an interior envelope (41), the interior envelope (41) including a plurality of perforated longitudinal sections including distribution orifices (not represented) by each receptacle (not represented), each perforated section being disposed between two adjacent receptacles, the cumulative area of the orifices of each successive perforated section decreasing from the inlet (102) to the outlet (106) of the enclosure (10). In this variant air may be extracted in two different ways. One way is for the enclosure to include a gas or air distribution column with perforated longitudinal sections by each receptacle with the distribution column connected to the outlet of the enclosure. Air therefore circulates in the distribution column from the inlet to the outlet of the enclosure. Another way is for the receptacles to comprise perforated lower and upper walls. The air or the gas therefore circulates from the bottom of the enclosure to the outlet through the various receptacles.

In another variant depicted in FIG. 7 the enclosure (not represented) includes a plurality of receptacles (42) mobile about a horizontal axis (43), the inlet of each receptacle (42) including gas or air distribution orifices (not represented) in one of its vertical walls adapted to cause the gas or air (F3) to pass through the receptacle (42).

In this variant the air or gas may equally well be extracted in either of two different ways. A first way is for the axis to constitute a gas or air distribution tube provided with perforated longitudinal sections and the distribution column to be connected to the outlet of the receptacle. The air or gas that has passed through the plant material therefore enters the distribution column and circulates from the inlet to the outlet of the enclosure. Another way is for the receptacle to comprise a second vertical perforated wall opposite the first.

FIG. 4 represents an extraction method conforming to the invention employing an extraction system conforming to the invention.

The method includes a first step 200 during which a plant raw material, such as fresh flowers 2, is disposed in the enclosure or enclosures 10.

The method then includes a step 202 of extracting the gas or air obtained in the enclosure 10. In this example extraction is effected by aspiration of air via the outlet of the enclosure by means of the compression device 12.

The method then includes a step 204 of compressing the extracted air to a relative pressure greater than or equal to 2 bar and advantageously to a pressure between 3 and 5 bar inclusive.

The method then includes a step 206 of circulating the compressed air in the first capture device 14 during which compressed air passes through the first solvent, which enables capture by the first solvent of some of the volatile molecules mixed with the air.

The method then includes a step 208 of circulating the air extracted from the first capture device 14 in the second capture device 16 during which the air passes through the second solvent, which enables capture by the second solvent of some of the volatile molecules remaining mixed with the air.

The extraction, compression and circulation of air (or of gas) steps are advantageously executed in successive cycles with the system stopped between cycles. Each cycle may be defined by a predetermined duration, for example a duration of 30 minutes. In this case the method is executed intermittently, the extraction system functioning during the first predetermined duration, then being stopped during a second particular duration, equal for example to 30 minutes. Alternatively, each cycle may be defined by the duration required to obtain a first predetermined pressure, the cycle being interrupted when the predetermined pressure is reached. The predetermined pressure may for example be between 4 and 5 bar inclusive. The extraction system then remains stopped for a time necessary for the relative pressure to reach a second predetermined pressure, for example equal to 0.

The system and the method described hereinabove are particularly suitable for use in an industrial context, whether that be in terms of extraction yield (that is to say the quantity of product extracted for a given quantity of raw material), productivity (the quantity of material that can be treated in a given time), treatment capacity (the quantity of raw material that the system is able to accept in one use), and/or in terms of energy efficiency, because the system consumes little energy.

The volume of the enclosure is advantageously greater than 100 or even 150 litres, and generally between 100 and 1000 litres inclusive, in particular between 100 and 500 litres inclusive and for example between 120 and 200 litres inclusive. The use of two or more enclosures further enables the total treatment capacity of the system to be increased or a given treatment capacity to be achieved with enclosures of a smaller size.

The first capture device and/or the second capture device may advantageously include a device for evacuating the condensed water. Such a device includes for example a valve that can be controlled manually or automatically. An automatically controlled condensed water evaporation device will enable automatic evacuation of the condensed water while the extraction system is functioning. It will therefore not be necessary to interrupt the functioning of the extraction system if the condensed water risks reaching too great a volume.

At least a part of the enclosure 10 may advantageously be translucent or transparent so as to allow light to penetrate into the enclosure. In fact, depending on the type of flowers that it is wished to treat using the extraction system it may be useful for the flowers not to be in darkness (which can negatively influence the evolution of the flowers and also the quantity and quality of the volatile molecules emitted by the flowers).

The enclosure 10 may advantageously be equipped with a heating and/or temperature regulation system, for example to maintain the interior of the enclosure at a given temperature, for example a temperature between 10° C. and 50° C. inclusive, preferably between 10° C. and 30° C. inclusive, in particular between 20° C. and 30° C. inclusive.

The use of natural origin and non-polluting solvents have been described hereinabove. It can nevertheless be stated that the system conforming to the invention is compatible with the use of petrochemical solvents and also with the use of adsorbants as a replacement for the first and second solvents.

Use of the extraction system with circulation of air has been described hereinabove but there could be envisaged circulating other types of gas in the extraction system, and in particular an inert gas such as nitrogen. If a gas other than air is used the extraction system can be configured to function either in a closed circuit or in an open circuit (in which case continuous topping up with gas will have to be provided).

The invention also relates to the plant extract obtained by the method described above. This plant extract may constitute a food flavouring or preferably a perfume ingredient. The perfume ingredient may be used in particular in the manufacture of an accord, that is to say a combination of a few perfume ingredients, or in the production of a perfume that contains a more complex combination of perfume ingredients.

### EXAMPLES

### Example 1: Extraction From Flowers

An extraction system conforming to the invention depicted in FIG. 3 is used to obtain extracts from flowers.

Freshly harvested flowers are disposed in two distinct extraction cylinders. They are distributed uniformly in baskets and over the full height of the cylinders.

The same extraction solvent is placed in the two capture columns with a ratio by weight of 90:10.

The system is started up so that a flow of air passes alternately into one or the other of the cylinders for from 15 to 60 min, preferably 30 min.

The flowers are left in the cylinders for a time suitable for the correct conservation of the flowers, typically 8 to 48 h, preferably 24 h. At the end of this time the flowers are offloaded and replaced by fresh flowers.

This step is repeated until an appropriate flower/solvent ratio by weight of 20/1 to 200/1 is achieved depending on the olfactory power of the flowers treated.

Once this ratio is achieved, the solvent contained in the extraction columns is drawn off with the condensed water. The aqueous and organic phases are separated by condensation and the aqueous phase undergoes chemical treatment (saturation with salt) or physical treatment (centrifuging) in order to recover the part of the solvent dissolved in the water, which is then combined with the organic phases. The mixture obtained is dried to obtain the extract according to the invention.

### Example 2: Analysis of a Rose Extract

An extract of Rosa centifolia flowers (Extract 1) was obtained as described in Example 1 using triethyl citrate as the first and second solvents. The extract was analysed and compared to a rose absolute of the same species, commonly used in the perfumery field, but also the fraction from the head space of the fresh flower.

### 2A—Chromatographic Analysis

The comparative study of the chemical composition in terms of VOC (volatile organic compounds) between the fresh flowers, ingredients according to the invention and classic perfumery ingredients such as an absolute, was carried out by gas chromatography (GC) using an Agilent GC 7890B type system coupled to an MSD 5977B type mass spectrometer (MS). The sample was prepared in Headspace using the HiSorb (Markes International) technology. A HiSorb probe consists of a 75 mm inert stainless steel rod covered over a small area by a sorptive phase consisting of polydimethylsiloxane (PDMS). The extraction and/or desorption steps of the probe were automated on a Centri (Markes International) extraction and enrichment platform.

In the case of analysis of flowers the VOC were extracted by introducing freshly cut flowers into a bottomless 1 litre transparent glass flask closed by a silicone septum plug, outdoors, in sunlight, for 2 h after introducing the HiSorb probe.

Once the VOC had been extracted thermal desorption of the probe was carried out at 270° C. for 15 min with 2.5% of the incoming gas flow sent to a trap in order to concentrate the analysates before GC injection. This trap corresponds to a glass tube containing a porous polymer based absorbent (Tenax®). This trap was desorbed by rapid heating to 300° C. for 5 min and the gas flow sent to the GC column to enable analysis of the VOC.

VOC extraction was automated by means of the Centri extraction and enrichment platform during a step prior to the desorption of the HiSorb probe. 500 mg of sample were introduced into a 20 ml glass vial. This vial was first pre-incubated for 5 min at 40° C. with stirring at 500 rpm to make it possible to balance the flask at the extraction temperature. The apparatus then introduced the HiSorb probe into the vial to extract the VOC for 15 min at 40° C. with stirring at 500 rpm. The HiSorb probe was then desorbed under the same conditions as in the case of the capture of VOC from fresh flowers (15 min, 270° C.).

Chromatographic separation was obtained on a 30×0.25 m (0.25 μm) DB1-MS (Agilent) apolar column, using the following temperature gradient: isotherm at 250° C., 5 min; 3° C./min gradient to 120° C.; 5° C./min gradient to 250° C.; isotherm at 250° C., 5 min. The vector gas used was helium at a constant flowrate of 1.6 ml/min. Where detection by mass spectrometry is concerned, the temperature of the transfer line was set at 250° C., that of the ionisation source to 230° C., and the temperature of MS Quad to 150° C. The ion scanning range was between m/z 35 and m/z 550.

The results of these tests are set out in FIGS. 8 to 10.

As these figures show, the compounds present in the head fraction of the rose (FIG. 8) are found in greater number in Extract 1 (FIG. 9) than in the absolute (FIG. 10), in particular sabinene, beta-pinene, myrcene, alpha-phellandrene and gamma-terpinene.

### 2B—Sensorial Analysis

The analysis was carried out by a trained panel. The extract obtained in accordance with the invention was described as fresher compared to conventional rose extracts, closer to the olfactory characteristics of the flower, with lychee notes, and honeyed and powdered notes characteristic of Rosa centifolia.

### Example 3: Analysis of a Lily of the Valley Extract

An extract of lily of the valley flowers was obtained as described in Example 1, using triethyl citrate as the first and second solvents. This extract was analysed and compared to the head space fraction of the fresh flower using the method described in Example 2.

The comparative study of the chemical composition in terms of VOC (volatile organic compounds) between fresh flowers (FIG. 11) and ingredients in accordance with the invention (FIG. 12) shows that all the olfactory constituents of the flowers (apart from myrcine) are found in the extract in accordance with the invention.

1-18. (canceled)

19. System for extraction of volatile molecules from a plant raw material such as flowers, including:
at least one enclosure including a plurality of receptacles configured to receive a plant raw material, the enclosure being hermetically sealed against entry of gases and including an inlet and an outlet disposed at two ends of the enclosure, the enclosure being configured to generate a circulation of gas in the enclosure by each receptacle, with a closely similar or equal gas flow by each receptacle,
a compression device configured to adjust the pressure of the air or of a gas circulating from the enclosure to a capture system at a relative pressure greater than or equal to 2 bar, the capture system including:
a first capture device at least partly filled with a first solvent so as to enable an exchange between the first solvent and the compressed gas entrained by the compression device, and
a second capture device comprising an inlet connected to a pipe enabling air evacuated from the first capture device to be drawn into the second capture device, the second capture device being at least partially filled with a second solvent so as to enable an exchange between the second solvent and the compressed gas that has passed through the first capture device.

20. Extraction system according to claim 19, wherein the compression device includes an inlet connected to the outlet of the enclosure so as to aspirate the gas contained in the enclosure and includes an outlet connected to an inlet of the first capture device.

21. Extraction system according to claim 19, wherein the enclosure comprises an inlet and an outlet disposed at respective opposite ends of the enclosure, the inlet being connected to a gas or air distribution column passing through the enclosure, the distribution column including a tubular body, the tubular body including a plurality of perforated longitudinal sections including distribution orifices by each receptacle, each perforated section being disposed between two adjacent receptacles, the cumulative area of the orifices of each successive perforated section decreasing from the inlet to the outlet of the enclosure.

22. Extraction system according to claim 21, wherein the orifices are of identical size and shape, the number of orifices in each successive perforated section decreasing from the inlet to the outlet of the enclosure.

23. Extraction system according to claim 19, wherein the compression device is configured to supply a pressure greater than 2 bar and for example greater than 4 bar, preferably between 4 and 6 bar.

24. Extraction system according to claim 19, wherein the extraction system includes two enclosures, the outlet of each enclosure being connected to the inlet of the compression device.

25. Extraction system according to claim 24, which includes a selection device for each enclosure enabling activation or deactivation of the circulation of gas, the selection device enabling activation of the circulation of gas either selectively in one or the other of the two enclosures or in the two enclosures simultaneously, the selection device including for example one or more valves.

26. Extraction system according to claim 19, wherein the receptacles are stacked, each receptacle including a bottom wall and preferably a peripheral side wall.

27. Extraction system according to claim 26, wherein the bottom wall and/or the side wall of each receptacle include(s) a plurality of gas circulation orifices.

28. Extraction system according to claim 19, wherein the first solvent has a solubility in water less than or equal to 20% and preferably less than or equal to 10%.

29. Extraction system according to claim 19, wherein the second solvent is identical to the first solvent or different from the first solvent, the second solvent then being miscible with the first solvent.

30. Extraction system according to the claim 29, wherein the second solvent has a solubility in water less than or equal to 20% and preferably less than or equal to 10%.

31. Extraction system according to claim 19, wherein the first capture device and/or the second capture device include(s) a means for generating bubbles in the first and/or the second solvent, such as a turbine, a sintered filter, a nebulisation system or an ultrasound probe, preferably a porous metal filter, so that the gas entering the first capture device is constrained to pass through the filter before coming into contact with the first solvent and/or the gas entering the second capture device is constrained to pass through the filter before coming into contact with the second solvent.

32. Extraction system according to claim 19, wherein the first capture device and/or the second capture device include(s) a part forming a container for condensed water resulting from condensation occurring in the circulation of gas in the extraction system.

33. Method of extracting volatile molecules from a plant raw material such as flowers, comprising the following steps:
distributing a plurality of portions of a plant material in an enclosure fed with a gas such as air and configured to generate a circulation of said gas through each portion of plant material with a close or equal gas flowrate by each portion,
extracting the gas having circulated over all the plant material portions and compressing it to a relative pressure greater than or equal to 2 bar,
capturing the compressed gas in a first organic solvent having a solubility in water less than or equal to 20 wt % and separating by condensation the steam contained in the gas to obtain an depleted gas, a first organic phase and a first aqueous phase,
capturing the depleted gas in a second organic solvent having a solubility in water less than or equal to 20 wt %, preferably identical to the first organic solvent, and separating by condensation the steam contained in the gas to obtain a second organic phase, a second aqueous phase and a gas that is further depleted that is optionally recycled in step (a),
combining the two organic phases and optionally the organic compound present in the two aqueous phases to obtain a plant extract.

34. Method according to claim 33, the method including the following steps:
disposing a plant raw material in an enclosure of a system,
extracting the gas contained in the enclosure,
compressing the extracted gas to a relative pressure greater than or equal to 2 bar,
causing the compressed gas to circulate in a first capture device,
causing the gas exiting the first capture device to circulate in a second capture device,
wherein the system comprises:
at least one enclosure including a plurality of receptacles configured to receive a plant raw material, the enclosure being hermetically sealed against entry of gases and including an inlet and an outlet disposed at two ends of the enclosure, the enclosure being configured to generate a circulation of gas in the enclosure by each receptacle, with a closely similar or equal gas flow by each receptacle,
a compression device configured to adjust the pressure of the air or of a gas circulating from the enclosure to a capture system at a relative pressure greater than or equal to 2 bar, the capture system including:
a first capture device at least partly filled with a first solvent so as to enable an exchange between the first solvent and the compressed gas entrained by the compression device, and
a second capture device comprising an inlet connected to a pipe enabling air evacuated from the first capture device to be drawn into the second capture device, the second capture device being at least partially filled with a second solvent so as to enable an exchange between the second solvent and the compressed gas that has passed through the first capture device.

35. Plant extract obtainable by the method according to claim 33.

36. Plant extract according to claim 35, wherein the plant material consists of silent flowers.
